(19) United States
(12) Patent Application Publication
(10) Pub. No.: US 2005/0250086 A1
(43) Pub. Date: Nov. 10, 2005

(54) METHOD OF MODELING GRAVIMETRIC FLOW AND PLOTTING LAGRANGE POINTS

(76) Inventor: Lyle A. Johnson, Fort Lauderdale, FL (US)

Correspondence Address: Oltman, Flynn & Kubler, Ste. #415, 915 Middle River Drive, Fort Lauderdale, FL, 33304, US

(21) Appl. No.: 10/841,328

(22) Filed: May 10, 2004

(51) Int. Cl. G09B 23/00

(52) U.S. Cl. 434/284

(57) ABSTRACT

A method of creating a model of gravimetric flow around two, three and four dimensional representations of masses such as celestial bodies having overlapping gravity fields and plotting the Lagrange points at the correct positions in space between the bodies includes the steps of creating scale representations of the celestial bodies, plotting cascade lines for each celestial body by generating radial lines converging at each celestial body center of mass, the numbers of radial lines for each celestial body corresponding directly to the acceleration due to the relative masses of the celestial bodies and the centripital acceleration, the larger the mass the greater the number of radial lines, thereby revealing interfering regions indicating locations of the Lagrange points; and locating and marking the Lagrange points.

### FILING HISTORY

This application continues from and is based on the contents of Disclosure Document 542452 filed on Nov. 24, 2003.

### BACKGROUND OF THE INVENTION

1. Field of the Invention

The present invention relates generally to the field of modeling abstract natural phenomena. More specifically the present invention relates to a method of generating a model illustrating the characteristics of gravimetric flow between any number of masses according a novel theory proposed by applicant, and quantitatively and qualitatively determining the Lagrange points between the masses. According to this theory, gravity results from a cascade of particles or waves converging radially toward centers of mass such as of planets and moons, and passing through and interacting with all matter in their path. The method creates a model of gravimetric flow around two, three and four dimensional representations of the masses such as celestial bodies having overlapping gravitational fields and plotting the Lagrange points at the correct positions in space between the bodies, representing their true morphology. The method includes the steps of creating scale representations of the celestial bodies: plotting cascade lines for each celestial body by generating radial lines converging at each celestial body center of mass, the numbers of radial lines for each celestial body corresponding directly to the relative masses of the celestial bodies, thereby revealing interfering regions indicating locations of the Lagrange points; and plotting and marking the Lagrange points.

2. Description of the Prior Art

There have long been methods of generating models to illustrate theories explaining various natural phenomena. In most instances, the methods of modeling are unique because they depend in their construction on the particular theory and phenomenon involved.

It is thus an object of the present invention to provide a method of modeling a theory of gravity which illustrates relative gravity strength and the directions of gravitational force for multiple celestial bodies.

It is another object of the present invention to provide such a method which permits correct location plotting of Lagrange points.

It is still another object of the present invention to provide such a method which can generate a model in two, three or four dimensions.

It is finally an object of the present invention to provide such a method which can be adapted to represent any of various numbers and masses of objects such as celestial bodies.

### SUMMARY OF THE INVENTION

The present invention accomplishes the above-stated objectives, as well as others, as may be determined by a fair reading and interpretation of the entire specification.

A method is provided of creating a model of gravimetric flow around two, three and four dimensional representations of masses such as celestial bodies having overlapping gravitational fields and plotting Lagrange points at the correct positions in space between the bodies representing their true morphology, the method including the steps of creating scale representations of the celestial bodies, plotting cascade lines for each celestial body by generating radial lines converging at each celestial body center of mass, the numbers of radial lines for each celestial body corresponding directly to the relative masses of the celestial bodies and the centripital force, the larger the mass the greater the number of radial lines, thereby revealing interfering regions indicating locations of the Lagrange points; and plotting and marking the Lagrange points.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a schematic representation of a celestial body with radial lines converging toward the center of mass representing gravity.

FIG. 2 is a rough drawing of the earth-moon system constructed with 360 radials on each body.

FIG. 3 in a model of the earth/moon system with radials drawn proportional to gravimetric field strength showing the overlapping gravity fields and the Lagrange points.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### Theory and Model

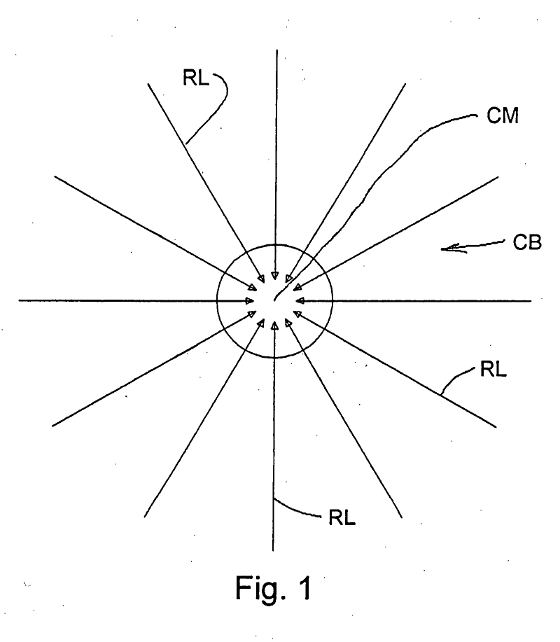

Referring to FIGS. 1-3, a method is disclosed of generating a model demonstrating the characteristics of gravimetric flow according a novel theory formulated by applicant. According to this theory, gravity results from a cascade of particles or waves converging radially toward centers of mass such as of planets and moons, passing through all matter in their path, and creating Lagrange points LP. Lagrange points LP, also known as a Lagrange equilibrium points, are the points between celestial bodies where their gravitational fields overlap and centripital force is cancelled out, and which each can retain a smaller body such as a man-made satellite. Sir Isaac Newton published his book Principia late in the 17th Century. Within its pages he revealed his famous law of universal gravitation. From that time on all of the motions of the heavenly bodies were understood. Newton's law of gravitation defines the pull of gravity between two objects. This simple one-to-one attraction leads to celestial motions that are basic geometric shapes—the circle, ellipse, parabola, and the hyperbola. The forces and motions of groups of three or more bodies remained undetermined for roughly 100 years. Then in 1772 Frenchman Joseph Lagrange solved the differential equations of three-body motion and discovered five points (L1-L5), surrounding two bodies (m and M) where those two could hold a third, small body (p), such as an asteroid or man-made satellite, in equilibrium with them. Further, he found that those points acted almost like centers of gravity and that the third body could move in an twisted-path orbit (librate) around any of these points.

The Lagrange points themselves act like centers of gravity so that the smaller body can move in an orbit around the point. Passage of these particles or waves through objects produces an interaction between the particles or waves and objects resulting in the weak force perceived as gravity.

The convergence of these cascading particles toward centers of mass is represented by radials, and according to the basic rules of geometry, the closer the observer comes to a center of mass CM, the more radials are intercepted and the greater the gravitational force. On earth, the magnitude of this force F is defined by:
F=mGM/r2
The present theory of cascading particle convergence at centers of mass explains previously observed phenomena, as set forth in Steven W. Hawking and W. Israel (eds) Three Hundred years of Gravitation (1987), including:

1. The inverse relationship between the magnitude of gravitational force and the distance between objects: as the distance from the center of mass CM increases, the number of interactions decreases, and gravitational force diminishes. The geometry of radial flow obeys the inverse square law.

2. The apparent curvature of space: the flow toward massive objects bends light as it passes nearby. What has been envisioned as a curvature of space is actually an external “push” on the light path exerted by the gravitational flow, that is by the cascade of particles.

3. The mass of a spherical body acts gravitationally as if the mass were concentrated at its center. This is consistent with the convergence of radials toward the center of mass CM according to the proposed theory.

4. The unexpected low gravity on top of mountains and the unexpected high gravity at ocean surfaces can be explained with the gravimetric flow model without having to resort to the idea of isostasy (low or high density rock). And as indicated in item 1 above, the greater the distance from the center of mass CM, the lesser the number of interactions and, as a result, the lesser the magnitude of gravitational force.

5. The lower: this expected solar neutrino flow: (neutrinos out)−(flow in)=⅓ of the expected number of neutrinos.

6. The null result in the Michelson Morley experiment: this result may have been caused by light beams measured perpendicular to particle cascade flow. Repeating the experiment, comparing the velocity of light beams both parallel and perpendicular to the radial flow should show a measurable difference in the speed of light (c).

The present theory also explains an observed technological phenomenon. The global positioning system (GPS), has, from its inception, exhibited markedly higher errors in the z axis (altitude) when compared to the other x and y axes (latitude and longitude). Since GPS relies solely on the timing of the signal to fix a position, there is no reason any one axis should have greater error than the other. Measurement at our laboratory with SA (selective availability) on and off tend to show an error 5-10 meters higher than the known elevation. Applicant learned last year that GPS engineers had developed “algorithms” in an attempt to compensate for this altitude error. Access to the raw data from the GPS system will be necessary to calculate the altitude error that applicant believes is due to gravimetric flow. In general, the signal in the z axis (altitude) appears to be traveling faster than in the other two axes.

The present theory also leads to the following predictions and explains several observations:

1. The gravitational “force” between two objects is not a force at all but a “shadow” where the radial flow of particles or waves from outside the universe is cancelled out.

2. Gravimetric flow originates outside the universe since the effects are seen on the galactic scale. It flows from an infinitely large extra-galactic object toward the atomic nucleus, probably the proton since it comprises approximately 75% of the mass of the universe. If the destination of the flow is indeed the proton, applicant proposes use of a Cavendish type experiment torsion balance to measure the deflection toward liquid hydrogen (99.8% protium). An equal mass of lead (proton/neutrino ratio−67%) or mercury (69%) should explain less deflection.

3. No deviations in the inverse square law due to the symmetry of the radial flow.

4. The Michelson Morley experiment could show the presence of the flow by measuring light path parallel to flow. Repeating the experiment and comparing beams parallel and perpendicular to flow may show a difference in speed. Yet that should not be necessary. If the flow exists, there should be a measurable difference between the GPS satellite signals for latitude and altitude or longitude and altitude. As it turns out, this is in fact the case. There is a 1.5-2.0 increase in error for altitude over either latitude or longitude. See Joe Mehaffey: GPS Altitude Readout>How accurate? Available online at: http://gpsinformation.net/main/altitude.htm.

5. The speed of light (c) is not independent of the Reference Frame. Therefore speeds of many multiples of c are possible and even demonstrable. Superluminal motion has been reported many times See J. Biretta Superluminal Motion in the M87 Jet Available online at: http://www.stsci.edu/ftp/science/m87/m87.html and recently a laboratory experiment observed a speed of 4.7 c. See Peter Weiss Light pulses flout sacrosanct speed limit Science News Jun. 10, 2000 Vol 157 Iss. 24; pg 375; and Wang, et al., Nature, 20 Jul. 2000.

6. Although the flow comes from outside our universe and appears omnidirectional, this may not be so. Astronomers have recently discovered that the universe is not only expanding, but is accelerating. See Riess, A. G. 2000. No Apparent challenge to accelerating universe from near IR observations of a high-redshift type is supernova. 195th Meeting of the American Astronomical Society. January 13. Atlanta. Abstract available at http://www.aas.org/publications/baas/v31n5/aas195/502.htm. This can happen only if the universe is being acted upon by an external force, and also, that force must have directionality. See John Ralston and Borge Noland, All Space is Not Equal: Physicists Find Axis that Gives Universe Orientation, Phisical Review Letters 78 (1997) 3043.

### Method

In practicing the invention, the following method may be used. A method is provided of creating a model of gravimetric flow around two, three and four dimensional representations of masses such as celestial bodies CB having overlapping gravitational fields and plotting Lagrange points LP at the correct positions in space between the bodies representing their true morphology, the method including the steps of creating scale representations of the celestial bodies CB, plotting cascade lines for each celestial body CB by generating radial lines RL converging at each celestial body center of mass CM, the numbers of radial lines RL for each celestial body CB corresponding directly to the relative masses of the celestial bodies CB, the larger the mass the greater the number of radial lines RL and compensating for centripital force, thereby revealing interfering regions indicating locations of the Lagrange points LP; and plotting and marking the Lagrange points LP.

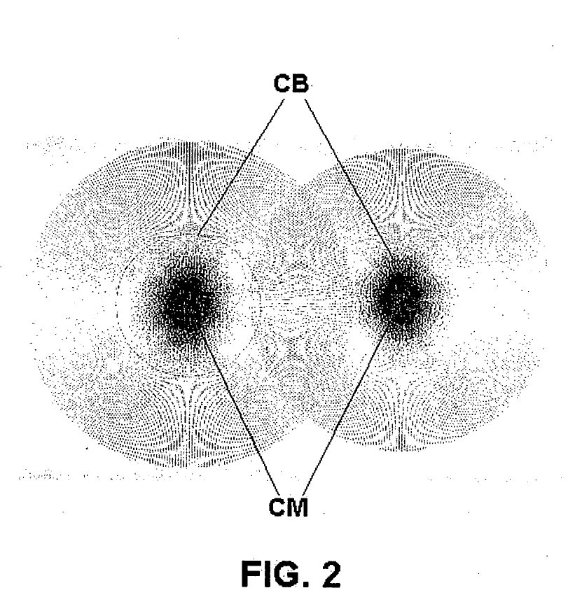

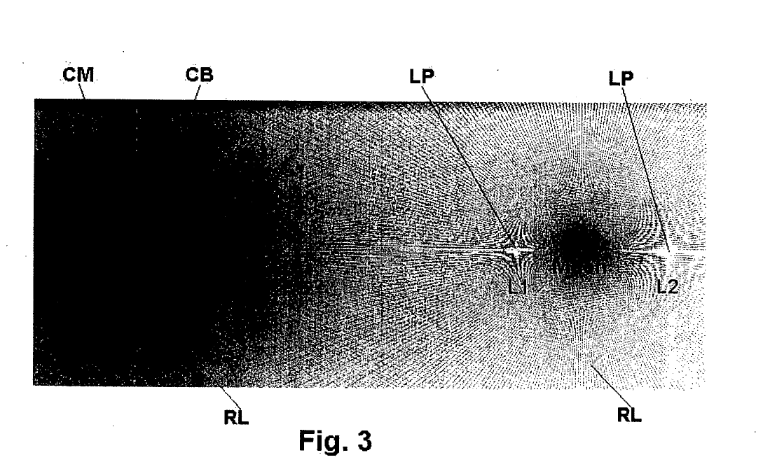

An example of such a plotted model is presented in FIG. 1, in which a CADD program simulated the earth-moon system to determine whether the “gravity shadow” of these two bodies would appear in a two dimensional representation. A rough drawing of the earth-moon system was constructed with 360 radials on each body. See FIG. 2. The interference pattern produced seems to indicate not only a “gravity shadow” but a representation of the Lagrange points LP. Another scaled CADD model was constructed with the added feature of the relative different values of gravity (g) for the earth and moon. The earth was assigned 1800 radials and the moon 300. (FIG. 3) Lagrange points LP (L1 and L2) are clearly visible and in their correct positions. A three-dimensional model of the Earth/Moon/Sun system is being developed by applicant. The plotting may be executed by computer.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

1. A method of creating a model of gravimetric flow around representations of bodies having overlapping gravitational fields and of locating Lagrange points at correct positions in space between the bodies representing their true morphology, the method comprising the steps of:
creating scale representations of the bodies;
locating cascade lines for each body by generating radial lines converging at each mass center of gravity, the numbers of radial lines for each mass corresponding directly to the relative acceleration due to the masses of the bodies and the centripetal acceleration, thereby revealing interfering regions indicating locations of the Lagrange points;
and locating the Lagrange points.

2. The method of claim 1, wherein the representations of the bodies are two dimensional.

3. The method of claim 1, wherein the representations of the bodies are three dimensional.

4. The method of claim 1, wherein the representations of the bodies have three dimensions in space and one dimension in time.

5. The method of claim 1, wherein the bodies are celestial bodies.

6. The method of claim 1, wherein the method is executed by a computer.

7. A method of creating a model of gravimetric flow around representations of celestial bodies having overlapping gravitational fields and of locating Lagrange points at correct positions in space between the celestial bodies representing their true morphology, the method comprising the steps of:
creating scale representations of the celestial bodies;
locating cascade lines for each body by generating radial lines converging at each mass center of gravity, the numbers of radial lines for each mass corresponding directly to the relative acceleration due to the masses of the celestial bodies and the centripetal acceleration, thereby revealing interfering regions indicating locations of the Lagrange points;
and locating the Lagrange points.

8. The method of claim 7, wherein the representations of the bodies are two dimensional.

9. The method of claim 7, wherein the representations of the bodies are three dimensional.

10. The method of claim 7, wherein the representations of the bodies have three dimensions in space and one dimension in time.
